(19) United States
(12) Patent Application Publication
(10) Pub. No.: US 2026/0069487 A1
(43) Pub. Date: Mar. 12, 2026

(54) MECHANICALLY ACTUATABLE STRUCTURAL ASSEMBLY WITH DYNAMICALLY CONFIGURABLE BUCKLING ARCH ELEMENT

(71) Applicant: Gulfstream Aerospace Corporation, Savannah, GA (US)

(72) Inventor: Johnny Ferguson, Savannah, GA (US)

(73) Assignee: Gulfstream Aerospace Corporation, Savannah, GA (US)

(21) Appl. No.: 18/830,161

(22) Filed: Sep. 10, 2024

(51) Int. Cl. B64D 11/06

(52) U.S. Cl. CPC A61H 7/004; B64D 11/0607; A61H 2201/0149; A61H 2201/1623; A61H 2201/1664

(57) ABSTRACT

A mechanically actuatable structural assembly, which may be utilized in a seating system, includes a base support layer, a buckling layer coupled to and overlying the base support layer, and a movable slider between the base support layer and the buckling layer. The buckling layer has an elastically deformable buckling arch element, and the movable slider is coupled to the buckling arch element to actuate the buckling arch element. When the movable slider is in an extended state, the elastically deformable buckling arch element is unloaded or preloaded to maintain a relaxed shape. When the movable slider is in a retracted state, the elastically deformable buckling arch element is subjected to compressive axial loading that causes the elastically deformable buckling arch element to buckle outwardly into a loaded arch shape.

### TECHNICAL FIELD

Embodiments of the subject matter described herein relate generally to support structures and assemblies of the type suitable for use with seats and seating systems. More particularly, embodiments of the subject matter relate to an actuatable support structure having at least one dynamically configurable support surface.

### BACKGROUND

Adjustable user support structures are commonly used in various applications such as seats and related seating systems, beds, massage and chiropractic tables, and the like. For example, adjustable seats are commonly deployed in different vehicle applications, including aircraft, automobiles, trains, and buses. Vehicle seating systems, for example, can be manually or electronically adjusted to change the angle of recline, to deploy a headrest, to extend an ottoman or leg rest, to change the shape or position of a lumbar support, to change the shape or size of side bolsters, or the like. As another example, most aircraft seats designed for business class or premium class passengers can be manually or electronically adjusted between an upright seating position and a flat (sleeping, berth) position.

Some adjustable seats include inflatable air bladders that can be inflated/deflated in a controlled manner to change the shape or contour of the seating surface. Unfortunately, such air bladders can be prone to leakage, susceptible to puncture, and expensive to manufacture, maintain, and replace. Accordingly, there is a need for a reliable alternative to an air bladder system that can be used in an adjustable support structure such as a vehicle seat. Furthermore, other desirable features and characteristics will become apparent from the subsequent detailed description and the appended claims, taken in conjunction with the accompanying drawings and the foregoing technical field and background.

### BRIEF SUMMARY

Embodiments of a mechanically actuatable structural assembly are presented here. In accordance with some embodiments, the structural assembly includes: a base support layer; a buckling layer coupled to and overlying the base support layer; and a movable slider disposed between the base support layer and the buckling layer. The buckling layer includes an elastically deformable buckling arch element, and the movable slider is coupled to the elastically deformable buckling arch element to actuate the elastically deformable buckling arch element. When the movable slider is in an extended state, the elastically deformable buckling arch element is unloaded or preloaded to maintain a relaxed shape. When the movable slider is in a retracted state, the elastically deformable buckling arch element is subjected to compressive axial loading that causes the elastically deformable buckling arch element to buckle outwardly into a loaded arch shape.

In accordance with certain embodiments, the mechanically actuatable structural assembly includes: a base support layer; at least one elastically deformable buckling arch element coupled to and overlying the base support layer; and means for applying a compressive axial load to the at least one elastically deformable buckling arch element. The compressive axial load causes the at least one elastically deformable buckling arch element to adaptively buckle outwardly and away from the base support layer. Removal of the compressive axial load causes the at least one elastically deformable buckling arch element to move inwardly and toward the base support layer, and to return to a relaxed shape.

Also disclosed herein is an embodiment of a seating system that includes at least one instance of a mechanically actuatable structural assembly of the type mentioned above.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a perspective view of an exemplary embodiment of a mechanically actuatable structural assembly, in an unloaded or preloaded state;

FIG. 2 is a perspective view of the structural assembly, in a loaded or actuated state;

FIG. 3 is a top view of the structural assembly, in the unloaded or preloaded state;

FIG. 4 is a perspective view of the structural assembly, in the loaded or actuated state;

FIG. 5 is a side view of the structural assembly, in the unloaded or preloaded state;

FIG. 6 is a side view of the structural assembly, in the loaded or actuated state;

FIG. 7 is a diagram that schematically illustrates an activation mechanism suitable for use with the structural assembly;

FIG. 8 is an exploded perspective view of the structural assembly;

FIG. 9 is a top view of an exemplary embodiment of a base support layer that can be used with the structural assembly;

FIG. 10 is a top view of an exemplary embodiment of a movable slider that can be used with the structural assembly;

FIG. 11 is a top view of an exemplary embodiment of a guide layer that can be used with the structural assembly;

FIG. 12 is a top view of an exemplary embodiment of a buckling layer that can be used with the structural assembly;

FIG. 13 is a top perspective view of the structural assembly without its buckling layer, and in the unloaded or preloaded state;

FIG. 14 is a top perspective view of the structural assembly without its buckling layer, and in the loaded or actuated state; and

FIG. 15 is a schematic representation of an embodiment of a seating system that incorporates mechanically actuatable structural assemblies of the type disclosed here.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

In the following description, certain terminology may be used for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

Disclosed herein is a dynamic morphing (shape-shifting) mechanically actuatable support mechanism that can be actuated to place it into different load-bearing or user-supporting states, such as a relatively flat shape and a relatively contoured or curved shape. In accordance with certain embodiments, the disclosed mechanisms and support structures can be utilized onboard a vehicle such as an aircraft. For example, the figures depict exemplary embodiments of a mechanically actuatable structural assembly that is suitably configured for use with an aircraft seat. However, it should be appreciated that embodiments of the disclosed subject matter can be utilized for other vehicle applications including, without limitation: trains; helicopters; automobiles; watercraft; monorails; amusement park rides; transportation systems; ski lifts; or the like. Moreover, embodiments of the disclosed subject matter can also be utilized with non-vehicle applications including, without limitation: residential applications; commercial applications; office space applications; recreational equipment; etc. These and other applications, use cases, and platforms are contemplated by this disclosure.

Some conventional aircraft seats use contoured foam to provide comfort for seating during extended flight times; some aircraft seat systems can be laid flat for berthing. The contoured seat surfaces may require a mattress placed over the seating surfaces to provide a smooth surface for sleep comfort. The mattresses add weight and consume valuable cargo space in the aircraft. Having a seat that can adapt without the need for mattresses would save fuel and cargo space. To this end, the dynamic structural assemblies disclosed here can be implemented to provide an adjustable seat surface that is suitable for aircraft applications. Certain embodiments of the dynamic seat surface use elastically deformable panels to form actuators, and Bowden cables as actuation mechanisms to move the foundation of the seat cushion for purposes of adapting the seating surface. When the system is in a relaxed state, the panels exhibit a virtually flat or gently raised configuration, allowing the seat to be laid flat for berthing without the need of a mattress. As the seat back is lifted to the reclined or seated position, the panels are expanded by actuating one or more Bowden cables. As the actuators expand, they lift supporting seat panels to create the profile of a comfortable seat.

In accordance with certain embodiments, a mechanically actuatable structural assembly can be used to create supporting and/or massage elements within a seat. Such an assembly may incorporate one or more dynamically configurable buckling arch elements that can be combined in an array or in a series of components to create various massage points throughout the seating surface. When fabricated using flexible thin plastic sheets or layers, the buckling arch elements can be placed below a foam layer of the seating surface to vary the presence and magnitude of “pressure points” that can be experienced by the occupant of the seat. The buckling arch elements can be actuated in a desired pattern or in a programmed cycle using a suitably configured and controlled activation mechanism. In this way, the structural assembly can provide different types and levels of massage as desired by the occupant.

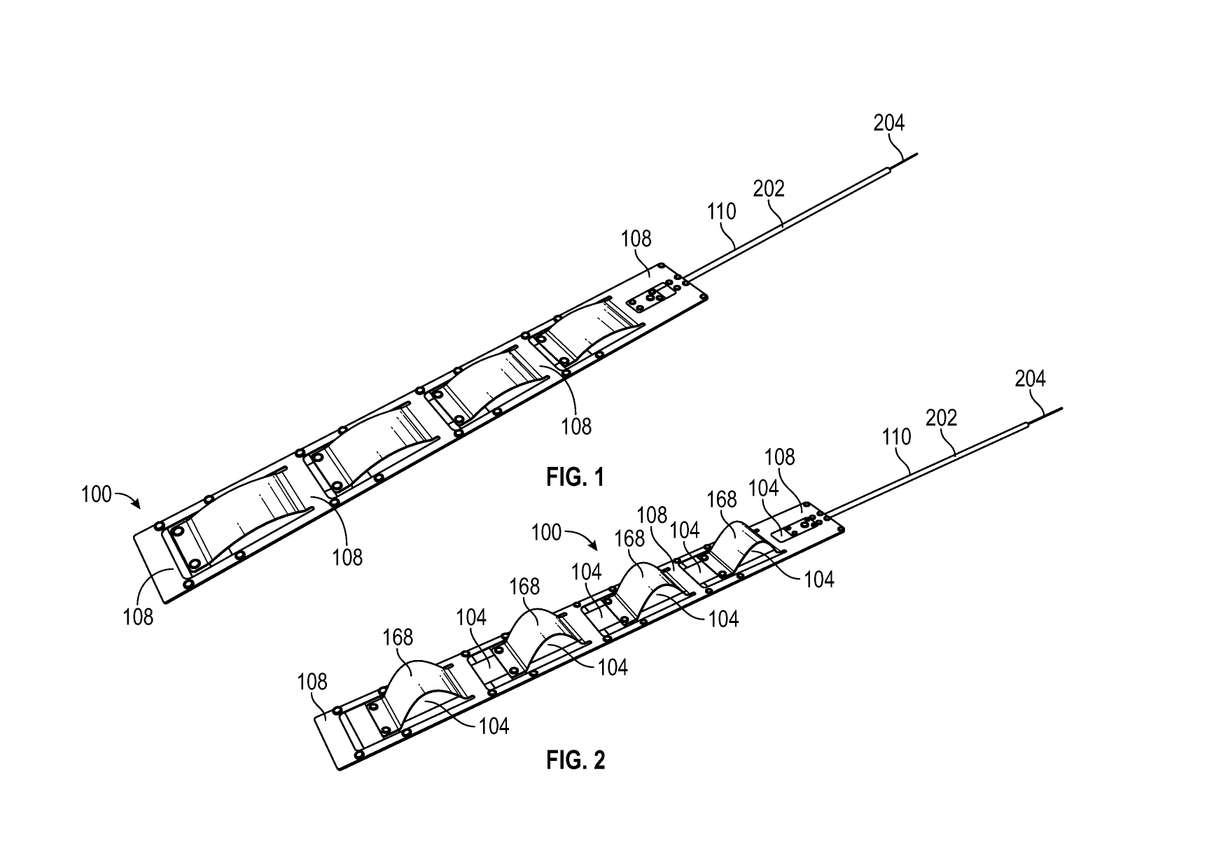

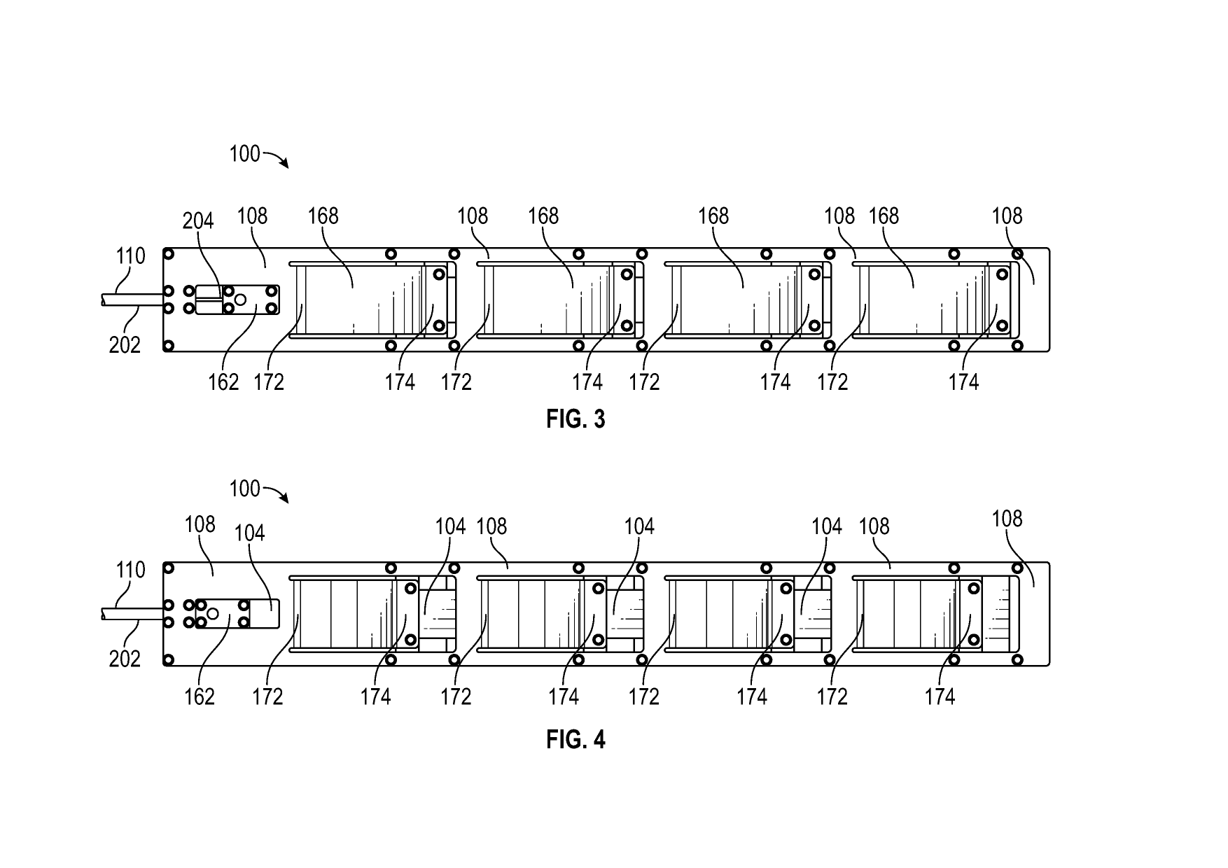

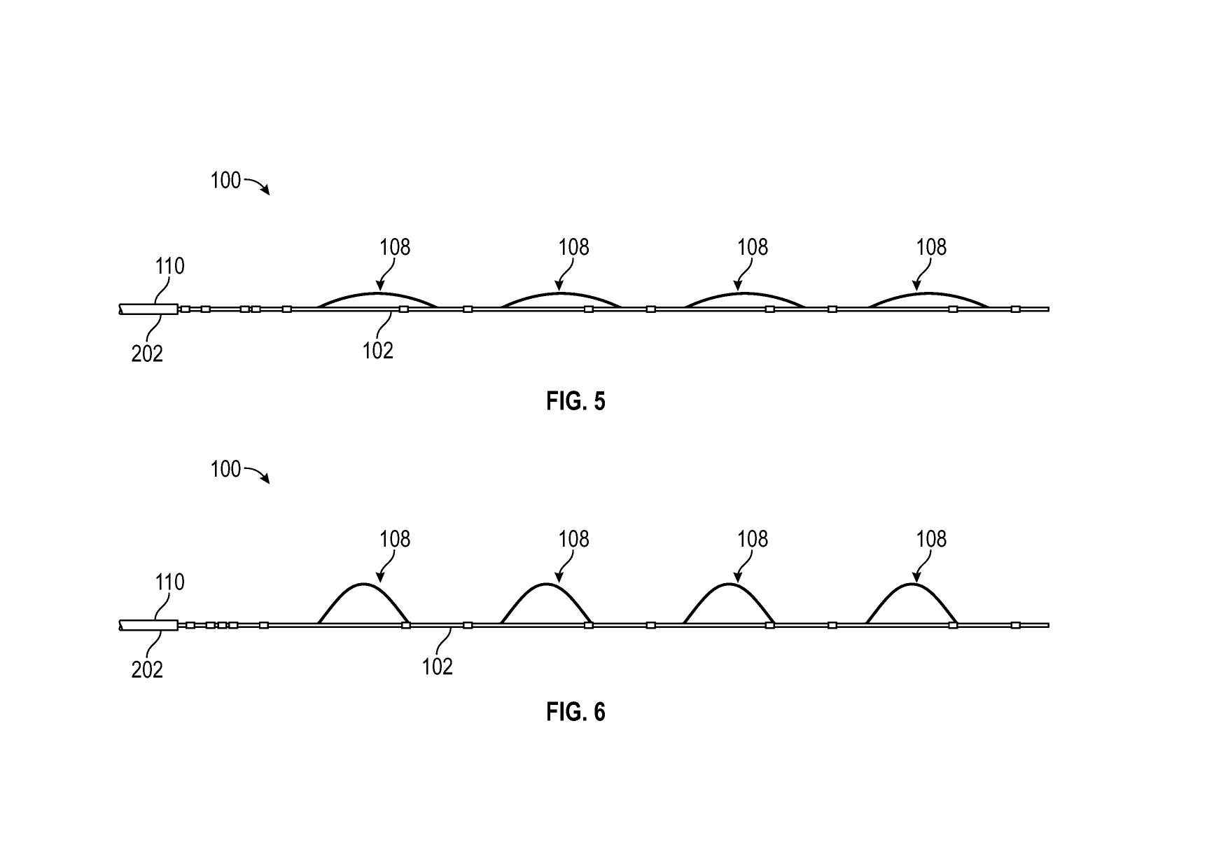

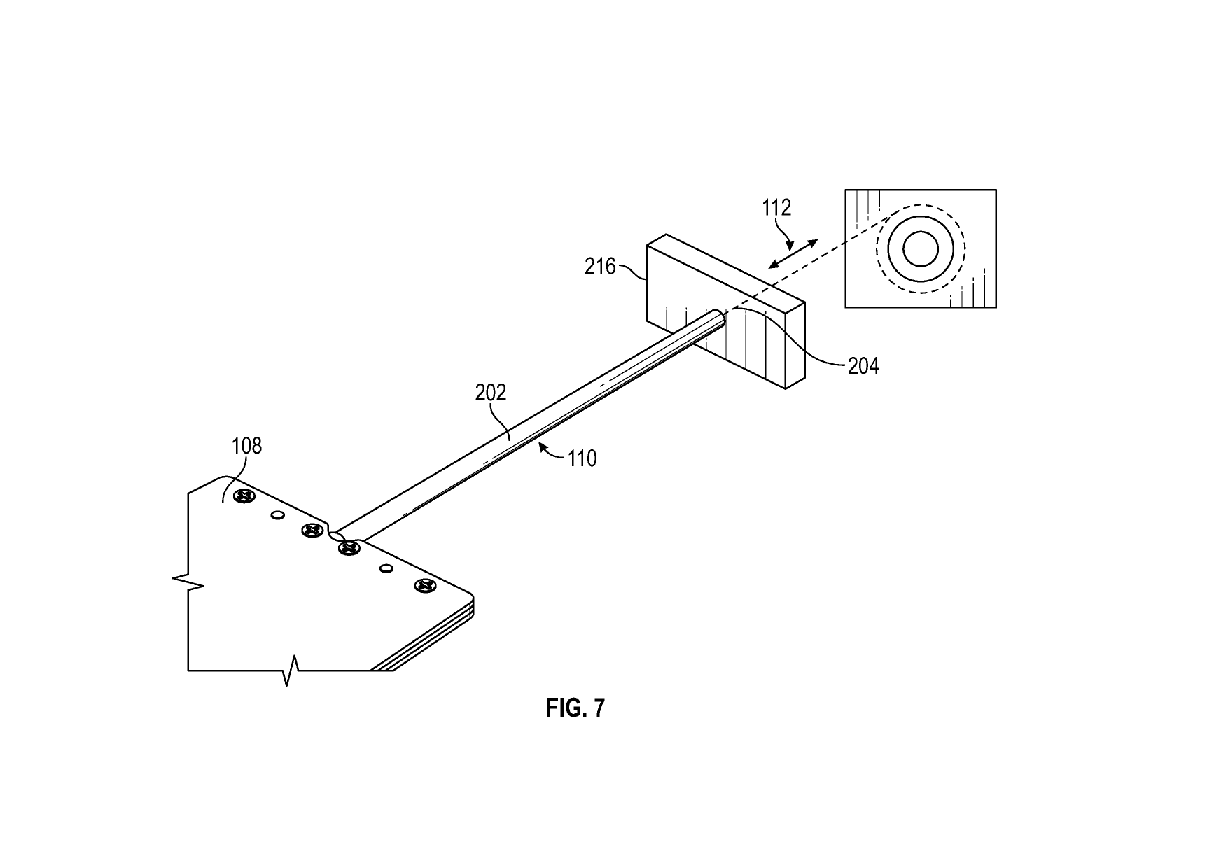

Referring to the drawings, FIGS. 1-6 relate to an exemplary embodiment of a mechanically actuatable structural assembly 100. The structural assembly 100 is generally rectangular in shape when viewed from the top or bottom. FIG. 1 is a perspective view of the structural assembly 100 in an unloaded or preloaded state, FIG. 2 is a perspective view of the structural assembly 100 in a loaded or actuated state, FIG. 3 is a top view of the structural assembly 100 in the unloaded or preloaded state, FIG. 4 is a perspective view of the structural assembly 100 in the loaded or actuated state, FIG. 5 is a side view of the structural assembly 100 in the unloaded or preloaded state, and FIG. 6 is a side view of the structural assembly 100 in the loaded or actuated state. FIG. 7 is a diagram that schematically illustrates an activation mechanism suitable for use with the structural assembly 100.

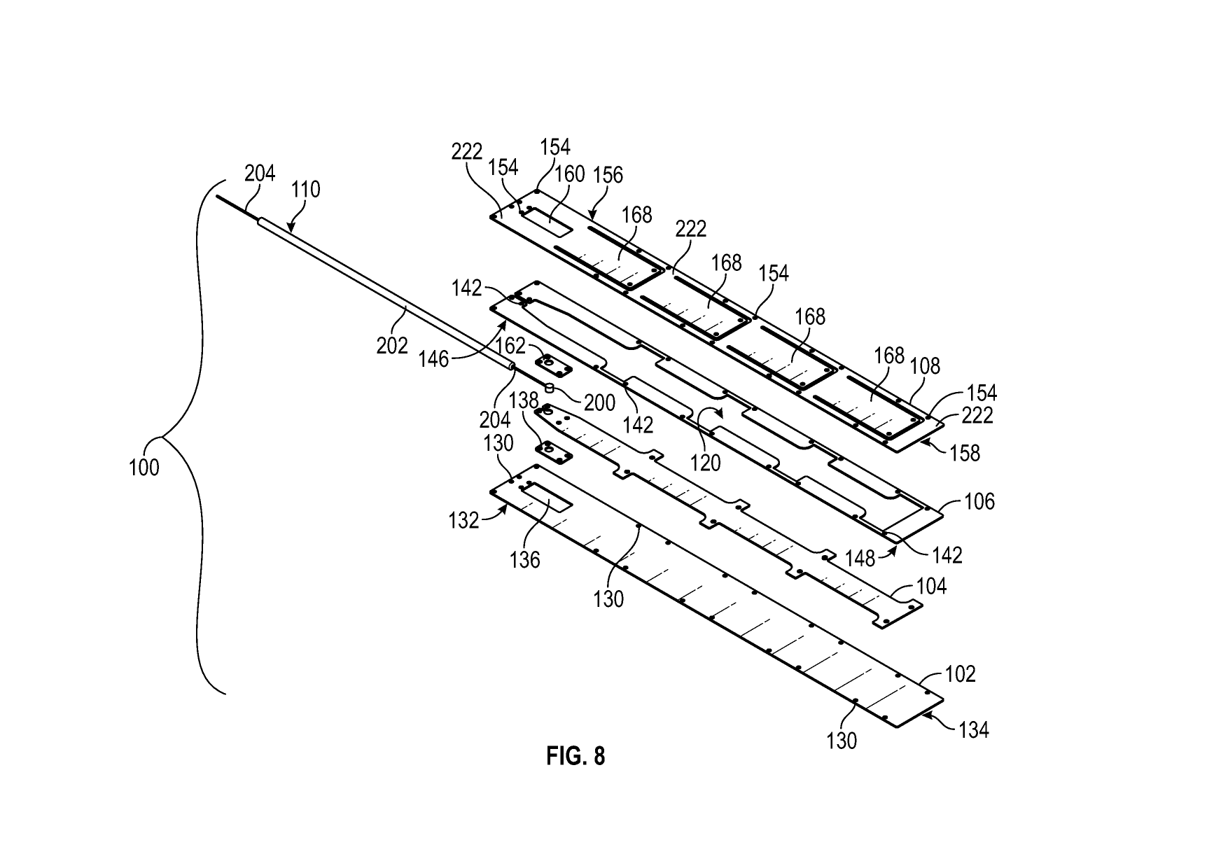

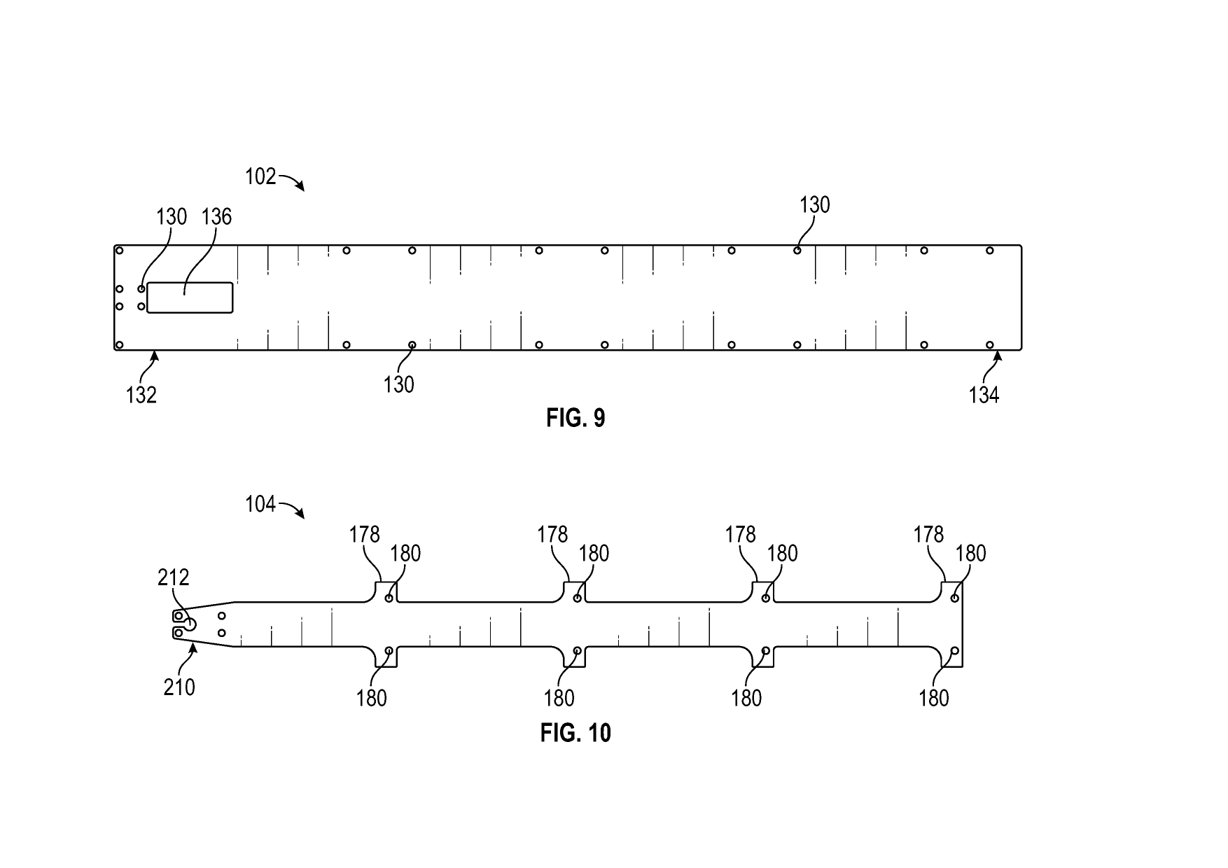

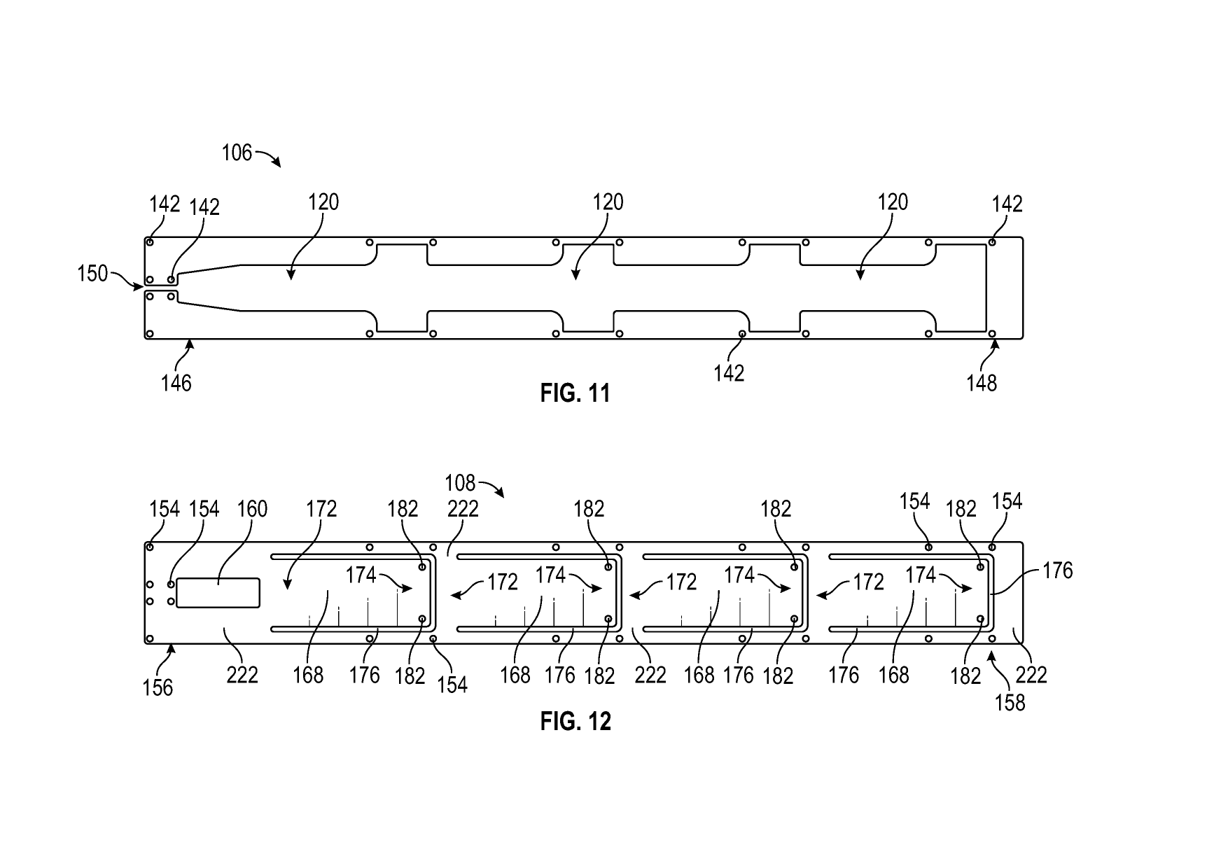

FIGS. 8-12 show some of the individual components of the structural assembly 100. More specifically, FIG. 8 is an exploded perspective view of the structural assembly 100, FIG. 9 is a top view of an exemplary embodiment of a base support layer 102 that can be used with the structural assembly 100, FIG. 10 is a top view of an exemplary embodiment of a movable slider 104 that can be used with the structural assembly 100, FIG. 11 is a top view of an exemplary embodiment of a guide layer 106 that can be used with the structural assembly 100, and FIG. 12 is a top view of an exemplary embodiment of a buckling layer 108 that can be used with the structural assembly 100. These and other components and features of the structural assembly 100 are described in more detail below.

The illustrated embodiment of the structural assembly 100 generally includes, without limitation: the base support layer 102; the movable slider 104; the guide layer 106; the buckling layer 108; and an actuation assembly 110. The structural assembly 100 may also include or cooperate with an activation mechanism 112 that controls operation of the actuation assembly 110 in the manner described in more detail below. For simplicity and convenience, the activation mechanism 112 is schematically represented in FIG. 7, but is omitted from other figures.

The illustrated embodiment of the structural assembly 100 has a generally rectangular shape when viewed from the top or the bottom. However, different shapes, sizes, dimensions, and configurations can be selected to suit the needs and specifications of the particular application and use case. For example, the overall shape of the structural assembly 100 need not be polygonal, and need not be symmetrical about its longitudinal axis or its lateral axis. To this end, this disclosure contemplates rectangular embodiments, trapezoidal embodiments, triangular embodiments, polygonal embodiments, embodiments having one or more curved sides, segments, or sections, etc.

In accordance with certain embodiments, the base support layer 102, the movable slider 104, the guide layer 106, and the buckling layer 108 are all fabricated from elastic material (which may be the same type of elastic material or different types of elastic material). Notably, the buckling layer 108 is fabricated with a material that exhibits desirable elastic deformation properties to allow it to bend/buckle on demand and return to its relaxed or unloaded state without experiencing plastic deformation, cracking, or damage. To this end, the elastic material that forms the base support layer 102, the movable slider 104, the guide layer 106, and the buckling layer 108 may be any of the following, without limitation: plastic, nylon, metal spring steel, a composite material, a metal sheet, or the like. In preferred embodiments, the elastic material is a thermoplastic acrylic-polyvinyl chloride material, such as KYDEX material. The elastically deformable material has the desired static, dynamic, and mechanical properties that provide the durability, reliability, structural integrity, toughness, and elasticity needed for the applications described here. To this end, the elastic material has properties that enable the buckling layer 108 to support the anticipated loads and applied forces when in the relaxed state and when in a buckled (deployed) state. Likewise, the dimensions of the buckling layer 108, the panel thickness, the uniformity of the panel thickness, and/or other physical characteristics of the buckling layer 108 can be designed and engineered to suit the load-bearing specifications and shape-shifting requirements of the particular applications.

The main components of the structural assembly 100 are arranged and coupled together in a layered manner. In this regard, the base support layer 102 serves as the foundation of the structural assembly 100 and the buckling layer 108 serves as the occupant-facing element of the structural assembly 100. The base support layer 102, the movable slider 104, the guide layer 106, and the buckling layer 108 are coupled together in an appropriate manner to form a sandwich construction. More specifically, the guide layer 106 is positioned overlying the base support layer 102, and the buckling layer 108 is positioned overlying the guide layer 106. Accordingly, the buckling layer 108 is coupled to and overlies the base support layer 102, and the the guide layer 106 is coupled between the base support layer 102 and the buckling layer 108.

The movable slider 104 is disposed between the base support layer 102 and the buckling layer 108. In accordance with the illustrated embodiment, the guide layer 106 includes a guide opening 120 formed therein (FIG. 8, FIG. 11) that is shaped, sized, configured, and aligned to accommodate the movable slider 104. Accordingly, when the structural assembly 100 is in its assembled state, the movable slider 104 resides in the guide opening 120 and is free to slide back and forth within the guide opening 120 (within certain physical limits). Actuation of the movable slider 104 is described in more detail below.

Referring to FIG. 8 and FIG. 9, the base support layer 102 is rectangular in shape, and it may have a number of fastener holes 130 formed therein. Although not always required, the fastener holes 130 are shaped and sized to accommodate rivets that are used to fabricate the structural assembly 100. For reasons that will become apparent from the following description, most of the fastener holes 130 are located near the outer perimeter of the base support layer 102, as depicted in the figures.

The base support layer 102 has a proximal end 132 and a distal end 134 opposite the proximal end 132. The base support layer 102 includes a slot or an opening 136 formed in the proximal end 132. The opening 136 is shaped, sized, configured, and arranged to accommodate a lower retainer 138 (FIG. 8). As explained in more detail below, the opening 136 is sized to allow a limited amount of longitudinal travel of the lower retainer 138.

Referring to FIGS. 8 and 11, the guide layer 106 also exhibits a generally rectangular outer perimeter shape. Indeed, the outer shape, size, and dimensions of the guide layer 106 can be consistent with that of the base support layer 102. The guide layer 106 includes a number of fastener holes 142 formed therein. Although not always required, the fastener holes 142 are shaped and sized to accommodate rivets that are used to fabricate the structural assembly 100. For reasons that will become apparent from the following description, most of the fastener holes 142 are located near the outer perimeter of the guide layer 106, as depicted in the figures. In preferred embodiments, the arrangement of the fastener holes 142 match the arrangement of the fastener holes 130 (in the base support layer 102).

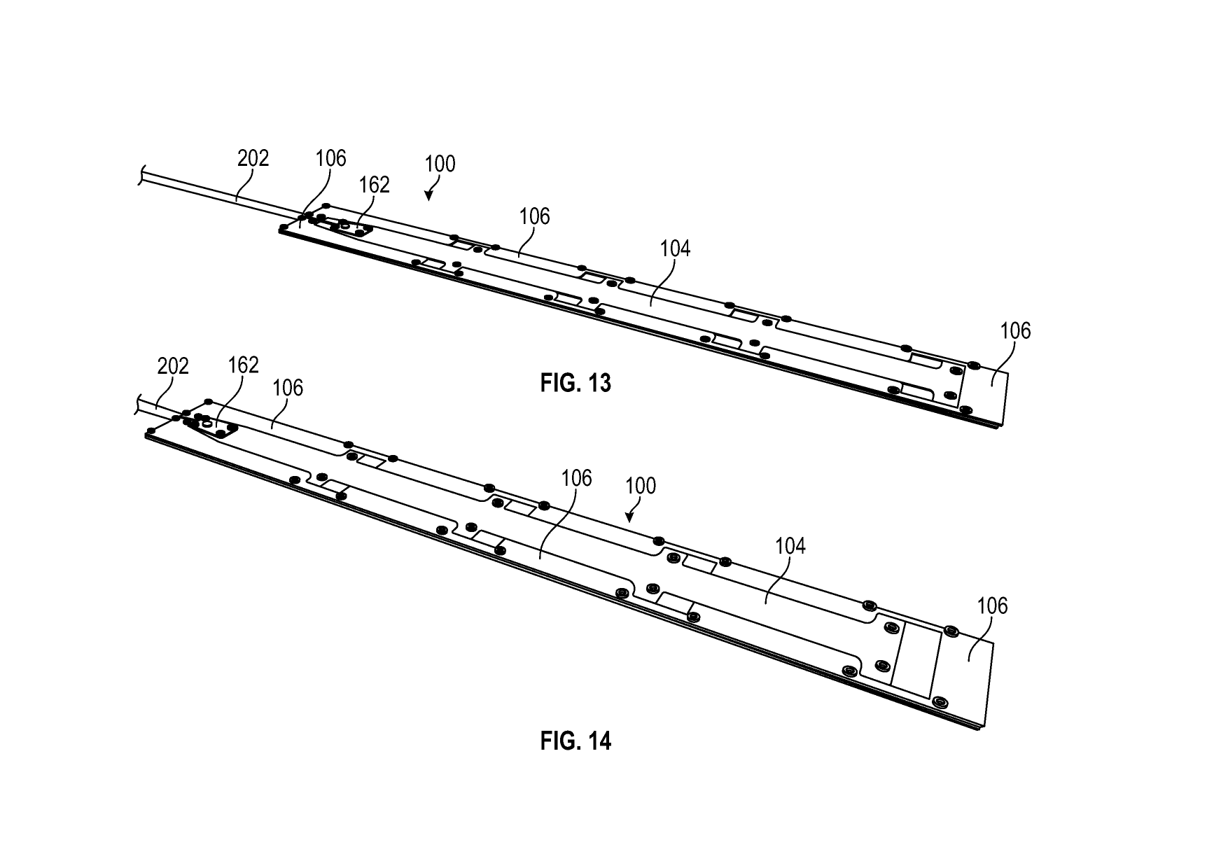

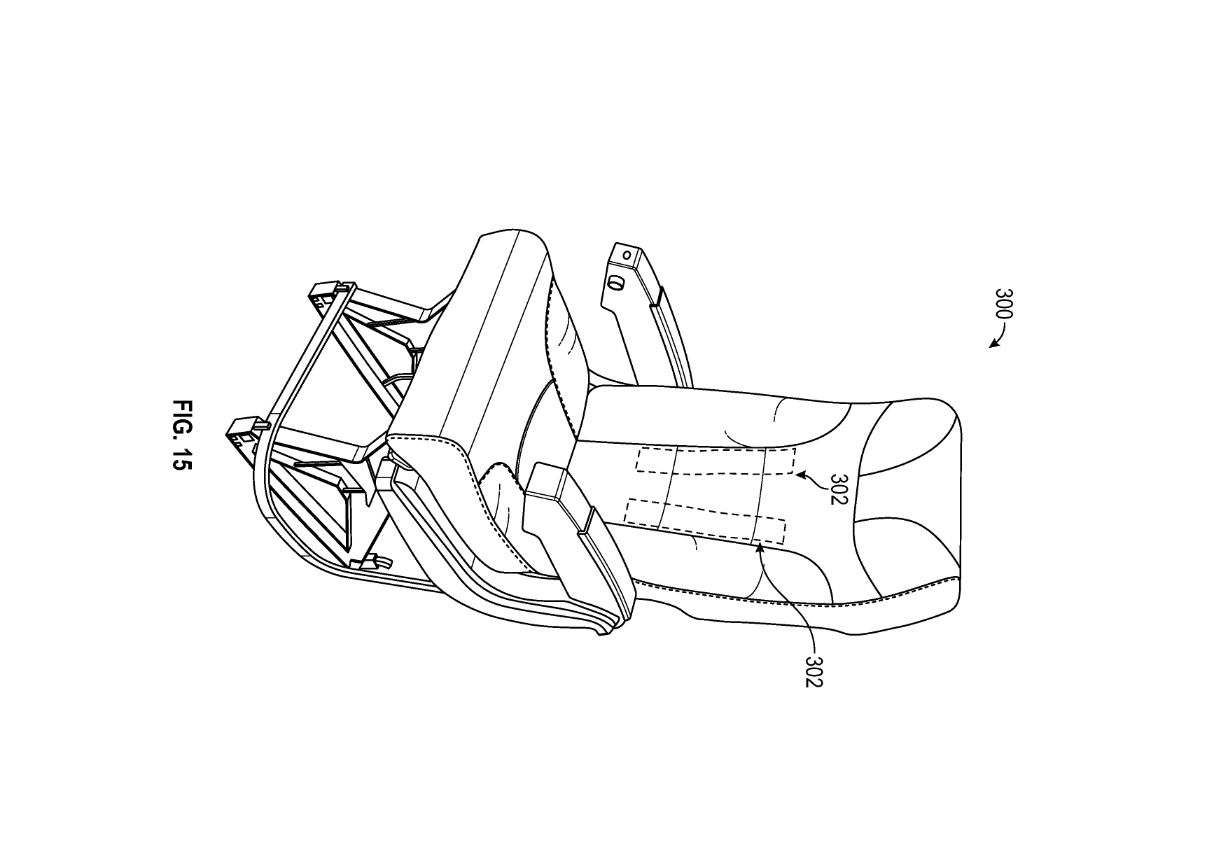

Referring to FIG. 11, the guide opening 120 is shaped, sized, configured, and arranged to receive the movable slider 104, and to accommodate longitudinal travel of the movable slider 104 (within certain physical limits as defined by the guide layer 106). In this regard, FIGS. 13 and 14 depict the structural assembly 100 without the buckling layer 108 in place. FIG. 13 shows the unloaded or preloaded state, and FIG. 14 shows the loaded or actuated state. These figures demonstrate how the guide opening 120 and the outer perimeter of the movable slider 104 are cooperatively configured such that the movable slider 104 fits within the space defined by the guide opening 120. For the depicted implementation, the guide layer 106 inhibits lateral shifting of the movable slider 104 while allowing longitudinal travel of the movable slider 104 (relative to the base support layer 102). During actuation of the structural assembly 100, the movable slider 104 slides within the guide opening between the extended state depicted in FIG. 13 and the retracted state depicted in FIG. 14. As mentioned above, the movable slider 104 is physically restricted within the space defined by the guide opening 120, the interior surface of the base support layer 102 that faces the bottom side of the movable slider 104, and the interior surface of the buckling layer 108 that faces the top side of the movable slider 104.

The guide layer 106 has a proximal end 146 and a distal end 148 opposite the proximal end 146. The guide layer 106 includes a slot or a cutout 150 formed in the proximal end 146. The cutout 150 extends from the outer perimeter of the guide layer 106 and leads into the guide opening 120. Accordingly, the cutout 150 can be considered to be an extension or portion of the guide opening 120. The cutout 150 is shaped, sized, and located to facilitate passage of a component of the actuation assembly, e.g., a cable.

Referring to FIGS. 8 and 12, the buckling layer 108 also exhibits a generally rectangular outer perimeter shape. Indeed, the outer shape, size, and dimensions of the buckling layer 108 can be consistent with that of the base support layer 102 and the guide layer 106. The buckling layer 108 includes a number of fastener holes 154 formed therein. Although not always required, the fastener holes 154 are shaped and sized to accommodate rivets that are used to fabricate the structural assembly 100. For reasons that will become apparent from the following description, most of the fastener holes 154 are located near the outer perimeter of the buckling layer 108, as depicted in the figures. In preferred embodiments, the arrangement of the fastener holes 154 match the arrangement of the fastener holes 130 (in the base support layer 102) and the fastener holes 142 (in the guide layer 106).

The buckling layer 108 has a proximal end 156 and a distal end 158 opposite the proximal end 156. The buckling layer 108 includes a slot or an opening 160 formed in the proximal end 156. The opening 160 is shaped, sized, configured, and arranged to accommodate an upper retainer 162 (FIG. 8). Moreover, the shape, size, arrangement, and alignment of the opening 160 can be consistent with that of the opening 136 that resides in the base support layer 102. As explained in more detail below, the opening 160 is sized to allow a limited amount of longitudinal travel of the upper retainer 162.

The buckling layer 108 has at least one elastically deformable buckling arch element 168 coupled thereto or integrated therein. In certain embodiments, such as the illustrated embodiment, the buckling layer 108 includes a plurality of buckling arch elements 168 arranged in series with one another. Although the figures show four buckling arch elements 168 arranged in longitudinal alignment with each other, an alternative implementation of the structural assembly 100 can include more of less than four buckling arch elements 168 arranged in any desired configuration, layout, array, matrix, or the like.

FIGS. 8 and 12 depict the buckling layer 108 in an unloaded state with no external force applied thereto. Consequently, the buckling layer 108 is relatively flat and planar in FIGS. 8 and 12, and the buckling arch elements 168 resemble rectangular shaped flaps that are integrally formed in the buckling layer 108. Referring to FIG. 12, each elastically deformable buckling arch element 168 includes or is realized as a flap having a hinged end 172 and a free end 174 opposing the hinged end 172. Each flap is defined by a respective slit or cutout 176 formed within the buckling layer 108. As shown in FIG. 12, each cutout 176 is characterized by two longitudinal and parallel legs, which are joined by a lateral segment. Although the figures show generally rectangular shaped flaps, alternate embodiments of the buckling layer 108 can utilize non-rectangular shaped flaps, asymmetrically shaped flaps, a combination of flaps having different shapes, or the like. Different shapes, sizes, and layouts of flaps can be utilized to provide the desired type of shape-shifting behavior, dynamic response, or the like.

Referring to FIGS. 2, 4, 8, 10, and 12, the movable slider 104 is coupled to the buckling arch elements 168 to actuate the buckling arch elements 168 on demand. In accordance with the illustrated embodiment, the movable slider 104 is coupled to all of the elastically deformable buckling arch elements 168 to concurrently actuate the buckling arch elements 168. For the illustrated embodiment, the movable slider 104 is coupled to each buckling arch element at or near the respective free end 174. In accordance with the depicted embodiment, the movable slider 104 includes four wing-shaped regions 178 that are shaped, sized, and arranged to fit within corresponding regions defined in the guide opening 120. each wing-shaped region 178 includes at least one fastener hole 180 formed therein. Although not always required, the fastener holes 180 are shaped and sized to accommodate rivets that are used to fabricate the structural assembly 100. Referring to FIG. 12, the buckling arch elements 168 have corresponding fastener holes 182 formed therein. The arrangement of the fastener holes 180 match the arrangement of the fastener holes 182 to facilitate coupling of the movable slider 104 to each buckling arch element.

Referring again to FIG. 7, the actuation assembly 110 represents a means for applying a compressive axial load to the elastically deformable buckling arch elements 168. In accordance with certain exemplary embodiments, the means for applying includes, is realized as, or cooperates with at least one Bowden cable that is controlled in an appropriate manner to apply the compressive axial load and to remove the compressive axial load (in a continuous manner, an incremental manner, a discrete manner, or the like). In certain embodiments, the means for applying may also include, be realized as, or cooperate with the movable slider 104. Alternatively or additionally, the means for applying includes, is realized as, or cooperates with at least one rod, at least one slat, at least one slider, at least one linkage, at least one piston, and/or at least one cam that is controlled in an appropriate manner to apply the compressive axial load and to remove the compressive axial load (in a continuous manner, an incremental manner, a discrete manner, or the like).

Although not always required, the illustrated embodiment of the actuation assembly 110 includes or is implemented as a Bowden cable, which is controlled by the activation mechanism 112 (schematically depicted in a simplified manner in FIG. 7). Accordingly, the actuation assembly 110 may include, without limitation: a stopper component 200 (see FIG. 8); a jacket component 202; and a movable loading element 204, which may be realized as a flexible cable.

The stopper component 200 is coupled to or is integrated with the distal end of the movable loading element 204, and it is utilized to secure the end of the movable loading element 204 to the distal end of the movable slider 104. Referring to FIG. 10, the distal end 210 of the movable slider 104 includes a cutout 212 formed therein. The cutout 212 is shaped to receive the stopper component 200 and a length of the movable loading element 204. The lower retainer 138 and the upper retainer 162 are coupled to the distal end 210 of the movable slider 104 after the stopper component 200 and the section of the movable loading element 204 are introduced into the desired position. Aligned and corresponding fastener holes in the movable slider 104, the upper retainer 162, and the lower retainer 138 facilitate attachment of the components together in a sandwich construction, thereby holding the stopper component 200 in place and fixed to the distal end 210 of the movable slider 104. The retainers 138, 162 also serve as structural reinforcement for the movable slider 104, such that it can withstand the loads applied by the actuation assembly 110 during operation of the structural assembly.

The jacket component 202 accommodates passage of the movable loading element 204, and an end of the jacket component 202 is configured to engage the distal end or edge of the structural assembly 100 (see FIGS. 1-4). The jacket component 202 need not be affixed or physically attached to the side of the structural assembly 100. Instead, the jacket component 202 can be held in place within a suitably configured and located slot, cutout, region, or feature by way of compressive force associated with operation or operating state of the activation mechanism 112. In other words, the activation mechanism 112 is configured to keep the movable loading element 204 under a nominal amount of tension, which urges the the jacket component 202 against the side of the structural assembly 100.

The stopper component 200 is rigid, durable, and is uncompressible relative to the material used to fabricate the movable slider 104. Likewise, the jacket component 202 is rigid, durable, and is uncompressible relative to the side edge of the structural assembly 100. The static and mechanical properties of the stopper component 200 and the jacket component 202 enable them to apply the desired amount of compressive axial force to the buckling layer 108. In certain embodiments, the jacket component 202 is realized as a metal tube that receives the movable loading element 204 and allows the movable loading element 204 to slide back and forth within the interior space defined in the jacket component 202. In some embodiments, the jacket component 202 is realized as a length of metal material that is wrapped into a spiral or helix shape to create a hollow space inside a strong and rigid outer wall.

The stopper component 200 moves, relative to the jacket component 202, during operation of the structural assembly 100. As schematically depicted in FIG. 7, one end of the jacket component 202 engages the end of the structural assembly 100, and the opposite end of the jacket component 202 engages or abuts a wall, a plate, a bulkhead, a frame element, or any suitably configured support structure 216. The arrangement of the jacket component 202 between the support structure 216 and the end of the structural assembly 100 keeps the end of the structural assembly 100 in a stationary position during actuation.

The activation mechanism 112 is controllable to pull the movable loading element 204 from an extended state to a retracted state, and to release the movable loading element 204 from a retracted state to an extended state. An embodiment of the activation mechanism 112 may include one or more electric motors, gears, spools, levers, linkages, a pneumatic subsystem, an electronic control unit, etc. The activation mechanism 112 can be suitably configured to control the operation of any number of structural assemblies 100 in a concurrent or individual manner, as appropriate for the particular application.

In accordance with certain applications, the structural assembly 100 can be fabricated in the following manner. As an initial step, the movable slider 104 is attached to the buckling arch element(s) 168 of the buckling layer 108 using, e.g., rivets or equivalent fasteners. Next, the guide layer 106 and the base support layer 102 are introduced and held in place, such that the fastener holes around the perimeter of the subassembly are in alignment (i.e., the base support layer 102, the guide layer 106, and the buckling layer 108 with attached movable slider 104 are held together and ready for fastening). Rivets or alternative fasteners are installed to secure the three primary layers together. Next, the Bowden cable components are installed, as follows. The proximal end of the cable (the free end opposite the stopper component 200) is fed through the passageway defined in the end of the subassembly until the stopper component 200 is near the passageway. If desired or necessary, the movable slider 104 is manipulated to preload the buckling layer 108 and to expose the distal end 210 of the movable slider 104. Manipulation of the movable slider 104 in this manner facilitates assembly of the stopper component 200 and the retainers 138, 162 onto the distal end 210 of the movable slider 104. Thereafter, the jacket component 202 can be introduced onto the movable loading element 204 and otherwise arranged as desired for the particular operating environment, use case, seating system, or the like.

FIGS. 1, 3, 5, and 13 depict the structural assembly 100 in a preloaded state, while FIGS. 2, 4, 6, and 14 depict the structural assembly 100 in a loaded state. For this particular example, a preloaded state can be achieved when the movable slider 104 is in an extended state. FIGS. 1, 3, 5, and 13 show the structural assembly 100 with the movable slider in its fully extended/released position. The fully extended position is reached when the distal ends of the retainers 138, 162 contact the “wall” that is defined by the opening 136 in the base support layer and the opening 160 in the buckling layer 108. When the movable slider 104 is in an extended state, each of the elastically deformable buckling arch elements 168 is unloaded or preloaded to maintain a relaxed shape.

When the structural assembly 100 is assembled and installed in the desired environment, the buckling arch elements 168 need not remain flat. Indeed, loading and actuation of the buckling arch elements 168 causes them to bend and move away from the base support layer 102. In this regard, the buckling layer 108 has an exterior surface that includes fixed surface regions 222 (see FIG. 8 and FIG. 12) that are intended to remain stationary (relative to the base support layer 102) during actuation of the buckling arch elements 168. The fixed surface regions 222 at least partially surround the buckling arch elements 168, and generally correspond to the area at or near the outer perimeter of the buckling layer 108, the proximal end 156, the distal end 158, and the sections between any two adjacent buckling arch elements 168. In contrast, the exterior surfaces of the buckling arch elements 168 are designed to be dynamic, adaptive, and movable. Thus, compressive axial loading imparted to the buckling arch elements 168 causes the exterior surfaces of the buckling arch elements 168 to rise above the fixed surface regions 222 by a height that is proportional to an amount of load that corresponds to the compressive axial loading. In other words, more compressive axial loading results in more buckling and increased height, and less compressive axial loading results in less buckling and decreased height.

The activation mechanism 112 can be controlled to retract the movable loading element 204, which in turn retracts the movable slider 104. Retracting the movable loading element 204 and the movable slider 104 results in compressive axial loading applied to the buckling arch elements 168. When a buckling arch element 168 is subjected to compressive axial loading, it buckles outwardly into a loaded arch shape that is different than its original preloaded or unloaded shape. Accordingly, the compressive axial load causes the buckling arch elements 168 to adaptively buckle outwardly in a controllable manner away from the base support layer 102. Conversely, reduction of the compressive axial load causes the buckling arch elements 168 to move inwardly and toward the base support layer 102. Minimizing or removing the compressive axial load causes the buckling arch elements 168 to return to their relaxed shape (as illustrated in FIGS. 1, 3, and 5).

A loaded state is achieved when the movable slider 104 is in a retracted state. FIGS. 2, 4, 6, and 14 show the structural assembly 100 with the movable slider 104 in its fully retracted/actuated position. The fully retracted position is reached when the proximal ends of the retainers 138, 162 contact the “wall” that is defined by the opening 136 in the base support layer and the opening 160 in the buckling layer 108. When the movable slider 104 is in the fully retracted state, each of the elastically deformable buckling arch elements 168 is loaded to achieve a fully loaded arch shape. In this way, the physical shape and contour of each buckling arch element 168 are dynamically reconfigurable in response to movement of the movable slider 104 relative to the base support layer 102. As demonstrated by FIGS. 1-6, retraction of the movable slider 104 causes the free end 174 of each buckling arch element 168 flap to move toward the hinged end 172 of the flap.

In accordance with the exemplary embodiments presented here, the free ends 174 of the buckling arch elements 168 travel by an amount that increases as a function of the compressive axial force/load applied thereto. Therefore, the amount of buckling of the buckling arch elements 168 is responsive to the axial compressive load imparted by the movable slider 104. Consequently, the overall height, the shape, and/or the volume defined below each buckling arch element 168 can be controlled in a dynamic and adaptive manner by the activation mechanism 112. Although the figures depict the two limits or endpoints of the movable slider 104, the activation mechanism 112 can be controlled and regulated to provide continuous or stepwise adjustment between the fully extended state and the fully retracted state of the movable slider 104.

Referring to FIG. 15, an exemplary embodiment of a seating system 300 includes two mechanically actuatable structural assemblies 302 of the type disclosed here. The structural assemblies 302 are illustrated in dashed lines because they would otherwise be hidden from view, incorporated underneath the exterior seat cover layer. In this regard, the structural assemblies 302 may be located within an interior pocket or space of the seat back, with appropriate padding, foam material, or comfort layers overlying the buckling layers. The buckling layers can be actuated to provide a massaging effect, to alleviate discomfort, to improve blood circulation, or the like. Although the seating system 300 is shown with two structural assemblies 302, an alternative implementation can utilize only one structural assembly 302 or more than two.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A mechanically actuatable structural assembly comprising:
a base support layer;
a buckling layer coupled to and overlying the base support layer, the buckling layer comprising an elastically deformable buckling arch element; and
a movable slider disposed between the base support layer and the buckling layer, the movable slider coupled to the elastically deformable buckling arch element to actuate the elastically deformable buckling arch element; wherein:
when the movable slider is in an extended state, the elastically deformable buckling arch element is unloaded or preloaded to maintain a relaxed shape; and
when the movable slider is in a retracted state, the elastically deformable buckling arch element is subjected to compressive axial loading that causes the elastically deformable buckling arch element to buckle outwardly into a loaded arch shape.

2. The mechanically actuatable structural assembly of claim 1, wherein physical shape of the elastically deformable buckling arch element is dynamically reconfigurable in response to movement of the movable slider relative to the base support layer.

3. The mechanically actuatable structural assembly of claim 1, further comprising a movable loading element coupled to the movable slider, wherein retracting the moveable loading element results in the compressive axial loading.

4. The mechanically actuatable structural assembly of claim 3, further comprising an activation mechanism coupled to the movable loading element, wherein:
the activation mechanism is controllable to pull the movable loading element from the extended state to the retracted state; and
the activation mechanism is controllable to release the movable loading element from the retracted state to the extended state.

5. The mechanically actuatable structural assembly of claim 1, further comprising a guide layer coupled between the base support layer and the buckling layer, wherein:
the guide layer comprises a guide opening formed therein;
the movable slider is disposed within the guide opening; and
the movable slider slides within the guide opening between the extended state and the retracted state.

6. The mechanically actuatable structural assembly of claim 5, wherein the moveable slider is physically restricted within a space defined by the guide opening, an interior surface of the base support layer, and an interior surface of the buckling layer.

7. The mechanically actuatable structural assembly of claim 1, wherein:
the buckling layer comprises an exterior surface having fixed surface regions that remain stationary, relative to the base support layer, during movement of the movable slider; and
compressive axial loading imparted to the elastically deformable buckling arch element causes an exterior surface of the elastically deformable buckling arch element to rise above the fixed surface regions by a height that is proportional to an amount of load that corresponds to the compressive axial loading.

8. The mechanically actuatable structural assembly of claim 1, wherein:
the elastically deformable buckling arch element comprises a flap having a hinged end and a free end opposing the hinged end; and
the moveable slider is coupled to the flap at or near the free end.

9. The mechanically actuatable structural assembly of claim 8, wherein retraction of the movable slider causes the free end of the flap to move toward the hinged end of the flap.

10. The mechanically actuatable structural assembly of claim 1, wherein:
the buckling layer comprises at least one additional elastically deformable buckling arch element; and
the movable slider is coupled to the at least one additional elastically deformable buckling arch element to concurrently actuate the elastically deformable buckling arch element and the at least one additional elastically deformable buckling arch element.

11. The mechanically actuatable structural assembly of claim 10, wherein the elastically deformable buckling arch element and the at least one additional elastically deformable buckling arch element are arranged in series.

12. A seating system comprising at least one instance of a mechanically actuatable structural assembly as recited in claim 1.

13. A mechanically actuatable structural assembly comprising:
a base support layer;
at least one elastically deformable buckling arch element coupled to and overlying the base support layer; and
means for applying a compressive axial load to the at least one elastically deformable buckling arch element, wherein the compressive axial load causes the at least one elastically deformable buckling arch element to adaptively buckle outwardly and away from the base support layer, and wherein removal of the compressive axial load causes the at least one elastically deformable buckling arch element to move inwardly and toward the base support layer, and to return to a relaxed shape.

14. The mechanically actuatable structural assembly of claim 13, further comprising a buckling layer coupled to and overlying the base support layer, wherein:
the buckling layer comprises the at least one elastically deformable buckling arch element; and
the means for applying comprises a movable slider disposed between the base layer and the buckling layer, the movable slider coupled to the at least one elastically deformable buckling arch element to actuate the at least one elastically deformable buckling arch element.

15. The mechanically actuatable structural assembly of claim 14, wherein:
when the movable slider is in an extended state, the at least one elastically deformable buckling arch element is unloaded or preloaded to maintain the relaxed shape; and
when the movable slider is in a retracted state, the at least one elastically deformable buckling arch element is subjected to the compressive axial load that causes the at least one elastically deformable buckling arch element to buckle.

16. The mechanically actuatable structural assembly of claim 14, further comprising a guide layer coupled between the base support layer and the buckling layer, wherein:
the guide layer comprises a guide opening formed therein;
the movable slider is disposed within the guide opening; and
the movable slider slides within the guide opening.

17. The mechanically actuatable structural assembly of claim 14, wherein:
the buckling layer comprises an exterior surface having fixed surface regions that remain stationary, relative to the base support layer, during movement of the movable slider; and
compressive axial loading imparted to the at least one elastically deformable buckling arch element causes an exterior surface of the at least one elastically deformable buckling arch element to rise above the fixed surface regions by a height that is proportional to an amount of load that corresponds to the compressive axial loading.

18. The mechanically actuatable structural assembly of claim 14, wherein:
the at least one elastically deformable buckling arch element comprises a flap having a hinged end and a free end opposing the hinged end; and
the moveable slider is coupled to the flap at or near the free end.

19. The mechanically actuatable structural assembly of claim 18, wherein retraction of movable slider causes the free end of the flap to move toward the hinged end of the flap.
